(19) United States
(12) Patent Application Publication
(10) Pub. No.: US 2026/0066308 A1
(43) Pub. Date: Mar. 5, 2026

(54) ANODE FOR ALL-SOLID-STATE BATTERY, METHOD FOR PREPARING ANODE FOR ALL-SOLID-STATE BATTERY AND ALL-SOLID-STATE BATTERY COMPRISING THE SAME

(71) Applicants: HYUNDAI MOTOR COMPANY, Seoul (KR); Kia Corporation, Seoul (KR); Seoul National University R&DB Foundation, Seoul (KR)

(72) Inventors: Ji Young Kim, Hwaseong-si (KR); Sam Ick Son, Hwaseong-si (KR); Ki Yoon Bae, Hwaseong-si (KR); Sang Heon Lee, Hwaseong-si (KR); Jang Wook Choi, Seoul (KR); Ji Hoon Oh, Seoul (KR); Do Hun Kwon, Seoul (KR); Noh Joon Lee, Seoul (KR); Ye Eun Sohn, Seoul (KR)

(21) Appl. No.: 19/064,340

(22) Filed: Feb. 26, 2025

(30) Foreign Application Priority Data
Aug. 27, 2024 (KR) 10-2024-0115351

(51) Int. Cl. H01M 4/62; H01M 4/02; H01M 4/04; H01M 4/133; H01M 4/1393; H01M 4/36; H01M 4/38; H01M 4/587; H01M 10/052

(52) U.S. Cl. CPC H01M 4/628; H01M 4/0404; H01M 4/0423; H01M 4/133; H01M 4/1393; H01M 4/366; H01M 4/386; H01M 4/587; H01M 10/052; H01M 2004/021; H01M 2004/027

(57) ABSTRACT

Provided are an anode for an all-solid-state battery, a method for preparing the same, and an all-solid-state battery including the anode. The anode includes an anode current collector, a lithium-friendly metal layer stacked on the anode current collector, and an anode active material layer stacked on the lithium-friendly metal layer, in which the anode active material layer includes a Si-based anode active material.

### CROSS-REFERENCE TO RELATED APPLICATION

This application claims the benefit of priority to Korean Patent Application No. 10-2024-0115351, filed in the Korean Intellectual Property Office on Aug. 27, 2024, the entire contents of which are incorporated herein by reference.

### TECHNICAL FIELD

The present disclosure relates to an anode for an all-solid-state battery, which is stably driven without a cell-short circuit under a higher capacity condition, as lithium deposition is stably induced without the growth of lithium dendrites, even when overcharged beyond theoretical capacity, a method for preparing the same, and the anode for the all-solid-state battery.

### BACKGROUND

Recently, a secondary battery has been widely employed in various fields such as an electric vehicle or a portable electronic device. In particular, active development of an all-solid-state battery has been pursued in an effort to achieve a higher energy density (Wh/L). Such an all-solid-state battery has been developed while focusing on the improvement in stability by replacing an existing liquid electrolyte with a solid electrolyte, and on the performance improvement in energy density and lifespan of the all-solid-state battery.

However, when a cathode with a higher capacity is employed to increase the energy density of the all-solid-state battery, an anode should be significantly thicker than the cathode. A thicker anode increases the volume and the weight of a cell, which creates a physical size limitation when increasing the whole energy density. In addition, excessive proportion differences between the cathode and the anode can create irregular precipitation of lithium and accelerate the formation of dendrites and the degradation of the cell. Accordingly, when the all-solid-state battery is driven for a longer time, the stability can degrade.

Accordingly, there remains a need to develop an anode material that is capable of stably receiving a higher capacity in the process of depositing and stripping lithium ions, while making a balance with a cathode material having a higher capacity to increase the energy density of the all-solid-state battery, and to develop the structure of the anode, capable of prohibiting lithium dendrites from being grown and of maintaining the stable charging/discharging characteristics.

### SUMMARY

The present disclosure addresses the above-mentioned problems of the prior art while maintaining the advantages of the technology.

An aspect of the present disclosure provides an anode (e.g., for an all-solid-state battery), capable of stably inducing lithium deposition without the growth of lithium dendrites, (e.g., even when overcharged), a method for preparing the same, and an all-solid-state battery including the anode.

In another aspect, the present disclosure provides a structure of an anode comprising an anode active material layer including a lithium-friendly metal layer and a Si-based anode active material stacked on the lithium-friendly metal layer. The anode, under charging operation, is capable of inducing lithium to be deposited under the anode active material layer.

The technical problems addressed by the present disclosure are not limited to the aforementioned problems, and any other technical advantages provided by the disclosure and not mentioned herein specifically will be clearly understood by those of skill in the art in light of the following description.

In general aspects, the present disclosure provides an anode for an all-solid-state battery, a method for preparing the same, and an all-solid-state battery using the same.

In some embodiments, (1) the present disclosure provides an anode for an all-solid-state battery, which includes an anode current collector, a lithium-friendly metal layer stacked on the anode current collector, and an anode active material layer stacked on the lithium-friendly metal layer, in which the anode active material layer includes a Si-based anode active material.

In some embodiments, (2) the present disclosure provides an anode for an all-solid-state battery, in which the Si-based anode active material has an electrochemical theoretical capacity of at least 100 mAh/g in (1).

In some embodiments, (3) the present disclosure provides an anode for an all-solid-state battery, the Si-based anode active material comprises a complex of Si or an active material selected from the group consisting of Si and graphite, lithium titanate (LTO), graphene, silicon-based oxide (SiOx), and a metal oxide, in (1) or (2).

In some embodiments, (4) the present disclosure provides an anode for an all-solid-state battery, in which the Si-based anode active material is a Si-graphite complex, in any one of (1) to (3).

In some embodiments, (5) the present disclosure provides an anode for an all-solid-state battery, in which the anode active material layer further includes a binder, in any one of (1) to (4).

In some embodiments, (6) the present disclosure provides an anode for an all-solid-state battery, in which an active material loading amount of the anode active material layer ranges from 0.2 mg/cm² to 1.8 mg/cm in any one of (1) to (5).

In some embodiments, (7) the present disclosure provides an anode for an all-solid-state battery, in which the anode active material layer further includes a solid electrolyte, in any one of (1) to (6).

In some embodiments, (8) the present disclosure provides an anode for an all-solid-state battery, in which the lithium-friendly metal layer includes at least one type selected from the group consisting of Mg, Ag, Zn, Au, Ni, Co, Mn, Al, Cd, and Ti, in any one of (1) to (7).

In some embodiments, (9) the present disclosure provides an anode for an all-solid-state battery, in which the lithium-friendly metal layer includes Mg, in any one of (1) to (8).

In some embodiments, (10) the present disclosure provides an anode for an all-solid-state battery, in which the lithium-friendly metal layer has a thickness ranging from 10 nm to 5,000 nm, in any one of (1) to (9).

In some embodiments, (11) the present disclosure provides an anode for an all-solid-state battery, in which lithium plating occurs under the alloy of the lithium-friendly metal layer and lithium formed in an overcharge state, in any one of (1) to (10).

In some embodiments, (12) the present disclosure provides a method for preparing an anode for an all-solid-state battery, which includes depositing a lithium-friendly metal layer on an anode current collector (S1), preparing anode active material slurry including Si (S2), and forming an anode active material layer by coating the anode active material slurry onto the lithium-friendly metal layer and drying a result (S3).

In some embodiments, (13) the present disclosure provides a method for preparing an anode for an all-solid-state battery, in which the S1 is performed through a physical vapor deposition scheme in (12).

In some embodiments, (14) the present disclosure provides a method for preparing an anode for an all-solid-state battery, in which the anode active material slurry has viscosity ranging from 100 cP and 200 cP in the S2, in (12) or (13).

In some embodiments, (15) the present disclosure provides a method for preparing an anode for an all-solid-state battery, in which the drying in the S3 is performing at a temperature ranging from 70° C. to 120° C., in any one of (12) to (14).

In some embodiments, (16) the present disclosure provides an all-solid-state battery according to (1).

### BRIEF DESCRIPTION OF THE DRAWINGS

The above and other objects, features and advantages of the present disclosure will be more apparent from the following detailed description taken in conjunction with the accompanying drawings:

FIGS. 1A and 1B depict representations of precipitation of lithium, when an anode is charged, according to an embodiment of the present disclosure (FIG. 1A) and Comparative Example 1 (FIG. 1B);

FIGS. 2A and 2B are SEM-EDS views illustrating a cross-section of an electrode in 100% of state of charge (SOC) of a cell employing an anode according to an embodiment of the present disclosure or Comparative example 1;

FIG. 3A is a view illustrating, in the form of a graph, an electrochemical characteristic of an anode according to an embodiment of the present disclosure and Comparative example 1;

FIG. 3B is a view illustrating, in the form of a graph, a coulombic efficiency, as the cycle of an anode is repeated according to an embodiment of the present disclosure and Comparative example 2;

FIGS. 4A and 4B are views illustrating, in the form of a graph, a voltage curve, when an anode is charged, according to an embodiment of the present disclosure and Comparative Example 1; and

FIGS. 5A, 5B, and 5C are views illustrating, in the form of a graph, an electrochemical characteristic of a cell employing an anode according to an embodiment of the present disclosure and Comparative example 1.

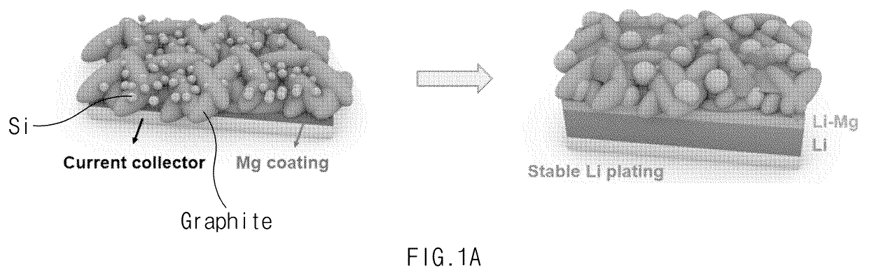

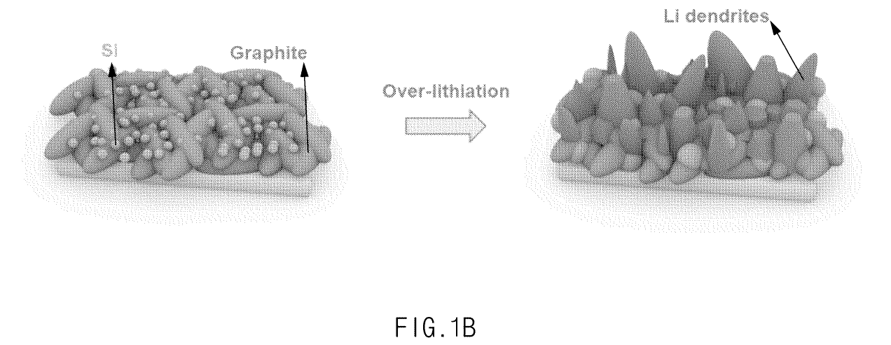

### DETAILED DESCRIPTION

Hereinafter, the present disclosure will be described in more detail.

The terminology or words used in the present specification and the claims shall not be interpreted as commonly-used dictionary meanings, but should be interpreted based on the technical scope of the present disclosure. Unless specifically defined in the specification, all terms should be understood to have their common and ordinary meanings as used in the relevant art, unless otherwise stated or redefined by the inventor to best explain the present disclosure.

### Anode for All-Solid-State Battery

The present disclosure provides an anode, e.g., for an all-solid-state battery or a cell, which includes an anode current collector, a lithium-friendly metal layer stacked on the anode current collector, and an anode active material layer stacked on the lithium-friendly metal layer. The anode active material layer includes a Si-based anode active material.

Hereinafter, components of the anode for the all-solid-state battery will be described in more detail.

### Anode Current Collector

According to the present disclosure, the anode current collector collects a current for allowing electrons to move to an external circuit of the all-solid-state battery, and provides a higher electrical conductivity such that the electrons rapidly move. The type of the anode current collector is not specifically limited, as long as the anode current collector has conductivity without causing the chemical change of the cell. In some non-limiting embodiments, the anode current collector may include at least one of copper, stainless steel, aluminum, nickel, titanium, sintered carbon, a surface treated material comprising copper or stainless steel surface treated with carbon, nickel, titanium, or silver, or an aluminum-cadmium alloy, or combinations thereof.

According to embodiments of the present disclosure, the thickness of the anode current collector is not specifically limited, as long as the thickness of the anode current collector ranges from 8 μm to 25 μm, and in some preferred embodiments, from 10 μm to 20 μm. According to the present disclosure, as long as the anode current collector satisfies the thickness condition, a higher energy density may be maintained without causing damage to the anode current collector

### Anode Active Material Layer

According to an embodiment, the anode active material layer is stacked on the lithium-friendly metal layer and configured to allow lithium ions to uniformly react on the entire electrode interface during a charging operation. The anode active material layer may include a Si-based anode active material. The electro-chemical theoretical capacity of the anode active material may range from 100 mAh/g to 5,000 mAh/g. Preferably, the electro-chemical theoretical capacity may be at least 500 mAh/g, or at least 800 mAh/g, and at most 4,500 mAh/g or at most 4,000 mg/g. As theoretical capacity of the anode active material satisfies the above range, the whole energy density of the cell may be increased. In addition, as many charges are stored and discharged under the condition of the higher current density, the cell performance under a higher-power condition may be improved. Accordingly, the energy efficiency of the cell may be improved.

In some embodiments, the Si-based anode active material comprises Si or a complex of Si with one or more materials selected from graphite, lithium titanate (LTO), graphene, silicon-based oxide (SiOx), and a metal oxide. More preferably, the Si-based anode active material may be a Si-graphite complex. According to the present disclosure, when the Si-graphite complex is employed as the anode active material, Si particles present between graphite particles help the diffusion of lithium ions between the graphite particles, such that the diffusion of the lithium ions is increased. Accordingly, lithium deposition may be more easily performed, thereby increasing the precipitation probability of overcharged lithium.

According to embodiments of the present disclosure, the loading amount of an active material in the anode active material layer may range from 0.2 mg/cm² to 1.8 mg/cm², and more preferably, may be at least 0.3 mg/cm², at least 0.4 mg/cm² or at least 0.5 mg/cm², and at most 1.4 mg/cm², at most 1.2 mg/cm² or at most 1.0 mg/cm². When the loading amount of the active material in the anode active material layer satisfies the above range, the energy density and the power characteristic of the cell may be improved, and the stress of the electrode may be reduced to improve a cycle life.

According to embodiments of the present disclosure, the anode active material may additionally include a binder. The binder may include various materials without being specifically limited, as long as the various materials fix materials of the anode active material layer. In some preferred embodiments, the binder may include at least one of polytetrafluoroethylene, polyethylene oxide, polyethyleneglycol, polyacrylonitrile, polyvinylchloride, polymethylmethacrylate, polypropyleneoxide, polyphosphazene, polysiloxane, polydimethylsiloxane, polyvinylidenefluoride, polyvinylidene fluoride-hexafluoropropylene copolymer (PVDF-HFP), polyvinylidene fluoride-chlorotrifluoroethylene copolymer (PVDF-CTFE), polyvinylidene fluoride-tetrafluoroethylene copolymer (PVDF-TFE), polyvinylidenecarbonate, polyvinylpyrrolidinone, styrene-butadiene rubber, nitrile-butadiene rubber, or hydrogenated nitrile butadiene rubber, or combinations thereof.

According to embodiments of the present disclosure, the anode active material layer may additionally include a solid electrolyte.

The solid electrolyte may be an inorganic solid electrolyte, such as a sulfide-based solid electrolyte, an oxide-based solid electrolyte, or a halide-based solid electrolyte, or a solid polymer electrolyte.

The sulfide-based solid electrolyte may be various general sulfide-based solid electrolyte without being specifically limited. In some preferred embodiments, the sulfide-based solid electrolyte may include at least one of Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which ‘m’ and ‘n’ are positive numbers; Z is one of Ge, Zn, and Ga), Li₂S—GeS₂, Li₂S—SiS₂—Li₃PO₄, Li₂S—SiS₂—LiₓMO_{y} (in which x and y are positive numbers; M is one among P, Si, Ge, B, Al, Ga, and In), or Li₁₀GeP₂S₁₂, or combinations thereof.

The oxide-based solid electrolyte may be various general oxide-based solid electrolyte without being specifically limited. In some preferred embodiments, the oxide-based solid electrolyte may include at least one of Li_{1+x+y}AlₓTi₂₋ₓSi_{y}P_{3-y}O₁: (wherein 0<x<2, 0≤y<3), BaTiO₃, Pb(Zr,Ti)O₃(PZT), Pb₁₋ₓLaₓZr_{1-y} Ti_{y}O₃(PLZT) (wherein 0≤x<1, 0≤y<1), PB(Mg₃Nb_{1/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (wherein 0<x<2, 0<y<3), LiₓAl_{y}Ti_{z}(PO₄)₃ (wherein 0 <x<2, 0<y<1, 0<z<3), Li_{1+x+y}(Al,Ga)ₓ(Ti, Ge)₂₋ₓSi_{y}P_{3-y}O₁₂ (wherein 0≤x≤1, 0≤y≤1), LiₓLa_{y}TiO₃ (wherein 0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (wherein ‘M’=Te, Nb, or Zr; 0≤x≤10), or Li₇La₃Zr₂₋ₓTaₓO₁₂ (wherein 0<x<2, LLZ-Ta), or combinations thereof.

The solid polymer electrolyte is not specifically limited, as long as the solid polymer electrolyte is a general solid polymer electrode. In some preferred embodiments, the solid polymer electrolyte may include at least one of poly(diallyldimethylammonium)TFSI), Cu₃N, Li₃N, LiPON, Li₃PO₄·Li₂S·SiS₂, Li₂S·GeS₂·Ga₂S₃, Li₂O·11Al₂O₃, Na₂O·11Al₂O₃, (Na, Li)₁₊ₓTi₂₋ₓAlₓ(PO₄)₃ (where 0.1<x<0.9), Li₁₊ₓHf₂₋ₓAlₓ(PO₄)₃ (where 0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-Silicates, Li_{0.3}La_{0.5}TiO₃, Na₅MSi₄O₁₂ (where ‘M’ is a rare-earth element such as Nd, Gd, or Dy), Li₅ZrP₃O₁₂, Li₅TiP₃O₁₂, Li₃Fe₂P₃O₁₂, Li₄NbP₃O₁₂, Li₁₊ₓ(M,Al,Ga)ₓ(Ge_{1-y}Ti_{y})₂₋ₓ(PO₄)₃ (where x≤0.8; 0≤y≤1.0; ‘M’ is Nd, Sm, Eu, Gd, Tb, Dy, Ho, Er, Tm or Yb), Li_{1+x+y}QₓTi₂₋ₓSi_{y}P_{3-y}O₁₂ (where 0<x≤0.4; 0<y≤0.6; ‘Q’ is Al or Ga), Li₆BaLaTa₂O₁₂, Li₇La₃Zr₂O₁₂, Li₅La₃Nb₂O₁₂, Li₅La₃M₂O₁₂ (where ‘M’ is Nb or, Ta), or Li₇₊ₓAₓLa₃₋ₓZr₂O₁₂ (where 0<x<3; ‘A’ is Zn), or combinations thereof.

In embodiments, the halide-based solid electrolyte may include a Li element, an M element (‘M’ is metal other than Li), and an X element (‘X’ is halogen). In some embodiments, ‘X’ may be for example, F, Cl, Br, and I. In further embodiments, the halide-based solid electrolyte is preferably at least one of Br or Cl. In some embodiments, ‘M’ may be a metal element, such as Sc, Y, B, Al, Ga, or In.

According to embodiments of the present disclosure, the anode active material layer may further include a conductive material. The conductive material may include various conductive materials without being specifically limited, as long as the conductive materials improve the electrical conductivity of the anode active material layer without causing the chemical change. As non-limiting examples, the conductive material may include at least one of carbon-based material, such as natural graphite, artificial graphite, carbon black, acetylene black, ketjen black, carbon fiber, and a carbon nano-tube; a metal-based material in the form of metal powders or metal fibers containing copper, nickel, aluminum, or silver; and a conductive polymer such as, for example, polyphenylene derivatives.

### Lithium-Friendly Metal Layer

According to an embodiment, the lithium-friendly metal layer is positioned under the anode active material layer. Accordingly, the lithium-friendly metal layer attracts lithium in an overcharging state to form an alloy and to deposit lithium metal under the alloy. In addition, the lithium-friendly metal layer includes metal showing an excellent interaction with lithium. Accordingly, when the lithium ions are deposited, the lithium-friendly metal layer provides an enhanced, or more stable, energy state, thereby inducing the lithium ions to be uniformly deposited between the alloy and the anode current collector, and inducing a uniform electrochemical reaction, such that the anode active material is stabilized.

The lithium-friendly metal layer may include metal having the overvoltage ranging from 1 mV to 50 mV when charging is made with the current density of 1 mA/cm² at a normal temperature. In embodiments, the overvoltage may be measured by charging/discharging a half-cell with a constant current under the condition of a voltage of at least 0.1 V. When the metal which is included in the lithium-friendly metal layer satisfies the range, the energy loss may be reduced, and the overvoltage may be improved in the electrochemical reaction, such that the cycle life may be increased. In addition, charging is stably made even under the higher current density.

The lithium-friendly metal layer may specifically include at least one of Mg, Ag, Zn, Au, Ni, Co, Mn, Al, Cd, or Ti. When the lithium-friendly metal layer includes the at least one of Mg, Ag, Zn, Au, Ni, Co, Mn, Al, Cd, or Ti, the reaction between the lithium-friendly metal layer and lithium may be actively made, and a lithium deposition reaction may be made on the lithium-friendly metal layer. In preferred embodiments, the lithium-friendly metal layer may include Mg.

According to embodiments of the present disclosure, the lithium-friendly metal layer may have a thickness ranging from 10 nm to 5,000 nm. In preferred embodiments, the lithium-friendly metal layer may have a thickness of at least 50 nm, at least 70 nm, or at least 100 nm, or at most 1,000 nm, at most 700 nm, or at most 500 nm. As the thickness of the lithium-friendly metal layer satisfies the range, lithium may be stably induced and deposited without significantly reducing the energy density.

### Method for Preparing Anode for All-Solid-State Battery

The present disclosure, in embodiments, provides a method (which hereinafter, may be referred to as a “preparing” method) for preparing an anode (e.g., for an all-solid-state battery), which includes depositing a lithium-friendly metal layer on an anode current collector (S1), preparing an anode active material slurry including Si (S2), and forming an anode active material layer by coating the slurry onto the lithium-friendly metal layer and drying the result (S3). Hereinafter, the preparing method according to some

embodiments of the present disclosure will be described in further detail.

### Depositing of Lithium-Friendly Metal Layer (S1)

In the method for preparing the anode for the all-solid-state battery according to the present disclosure, ‘S1’ refers to depositing the lithium-friendly metal layer on the anode current collector.

The deposition according to embodiments of the present disclosure may be performed through a sputtering scheme, an evaporation deposition scheme, a chemical vapor deposition scheme, an electrophoretic deposition scheme, an electroplating scheme, an atomic layer deposition scheme, and/or a physical vapor deposition scheme. In preferred embodiments, the deposition may be performed through the physical vapor deposition scheme. When the deposition is performed through the physical vapor deposition scheme, the lithium-friendly metal layer may be obtained at higher purity. Accordingly, the lithium-friendly metal layer may be strongly bonded, and the thickness of a thin film may be precisely controlled.

The description referring to the anode current collector and the lithium-friendly metal layer of the above-described anode for the all-solid-state battery is also applicable to the anode current collector and the lithium-friendly metal layer in this step.

### Preparing of Anode Active Material Slurry (S2)

In embodiments of the method for preparing the anode for the all-solid-state battery according to the present disclosure, ‘S2’ refers to preparing an anode active material slurry including Si.

In embodiments, the slurry according to the present disclosure may comprise a Si-based anode active material, a binder, and a solvent. The description referring to the anode active material and the binder of the above-described anode for the all-solid-state battery is also applicable to the anode active material and the binder.

The solvent may include various solvents without specifically being limited, as long as the solvents dissolve the anode active material and the binder. In some embodiments the solvent may include at least one of N-methyl-2-pyrrolidone (NMP), dimethylformamide (DMF), dimethyl sulfoxide (DMSO), tetrahydrofuran (THF), ethanol, isopropanol (IPA), acetone, ethylene carbonate (EC), propylene carbonate (PC), butyl butyrate (BB), xylene, or toluene, or combinations thereof.

In embodiments, the slurry may include a solid content ranging from 50 wt parts to 70 wt parts (i.e., 50-70% by weight). In such embodiments, the solid content in the slurry may provide for a slurry that is uniformly formed.

In some further embodiments, the slurry may have a viscosity ranging from 50 cP to 400 cP. More preferably, the slurry may have a viscosity ranging from 100 cP and 200 cP. In such embodiments, the viscosity of the slurry may provide for a uniform mixture, and the slurry may be coated onto the anode current collector, with a uniform thickness.

### Forming of Anode Active Material Layer (S3)

In some embodiments, the method for preparing the anode for the all-solid-state battery according to the present disclosure, ‘S3’ refers to forming the anode active material layer by coating the slurry, which is prepared in S2, onto the lithium-friendly metal layer deposited in S1 and drying the result.

The coating of the slurry according to the present disclosure is not specifically limited, as long as the slurry is uniformly coated onto the lithium-friendly metal layer.

In some embodiments, the drying may comprise drying the coated layer to evaporate the solvent, thereby forming the anode active material layer. The drying is not specifically limited, as long as the solvent is evaporated. For example, in embodiment the drying may be performed through an air drying scheme, an oven drying scheme, a vacuum drying scheme, or a microwave drying scheme.

The drying may be performed at the temperature ranging from 70° C. to 120° C. In some preferred embodiments, the drying may be performed at the temperature of at least 80° C., or at least 90° C., and at most 110° C. or at most 100° C. In such embodiments, the temperature range may provide for a more uniformly dried product, and minimize the amount of remaining solvent, such that any unstable electrochemically state is reduced, thereby improving or optimizing the electrical conductivity and the ion conductivity of the anode.

### All-Solid-State Battery

In embodiments, the present disclosure provides an all-solid-state battery including the anode.

The all-solid-state battery according to the present disclosure may include the anode of the all-solid-state battery according to the present disclosure, a cathode, and a solid electrolyte layer.

The solid electrolyte layer may include a solid electrolyte and a binder. The description referring to the solid electrolyte and the binder included in the anode described above is also applicable to the solid electrolyte and the binder.

In embodiments, the cathode may comprise a cathode active material layer coated onto a current collector, and the cathode active material layer may include a cathode active material, a binder, a conductive material, and a solid electrolyte. The description referring to the solid electrolyte, the binder, and the conductive material included in the anode described above is also applicable to the solid electrolyte, the binder, and the conductive material. In some embodiments, the cathode active material may include various materials without being specifically limited, as long as the materials are applied to a cathode in a typical all-solid-state battery and reversibly absorb and discharge lithium ions.

An illustrative embodiment of the present disclosure will be described in more detail in the Embodiments and Examples that follow. However, it will be appreciated that the illustrative Embodiments and Examples are not limiting to the scope of the present disclosure or appended claims.

### Embodiment

In accordance with embodiments of the above disclosure, the embodiment was prepared as follows: (S1) the lithium-friendly metal layer was deposited by depositing magnesium (Mg) onto the anode current collector including stainless steel, through a physical vapor deposition (PVD) scheme.

(S2) the anode active material slurry was prepared to have the viscosity of 100 cP by mixing butyl butyrate (BB) serving as the solvent with Si, graphite, and the solid electrolyte (LPSCI).

(S3) the anode active material slurry prepared in S2 was coated onto the lithium-friendly metal layer, and the result was dried at the temperature of 100° C., such that the anode active material layer including the Si-graphite complex serving as the active material is deposited on the lithium-friendly metal layer including Mg, thereby preparing the anode for the all-solid-state battery.

### Comparative Example 1

When compared to the above embodiment, the anode for the all-solid-state battery was prepared in the same manner as that of the embodiment, except that no Mg was deposited on the anode current collector.

### Comparative Example 2

When compared to the above embodiment, the anode for the all-solid-state battery was prepared in the same manner as that of the embodiment, except that Si is not contained in the anode active material slurry.

### Experimental Example 1: Evaluation for Cell—Cross-Section of Electrode Observed in 100% State of Charge (SOC)

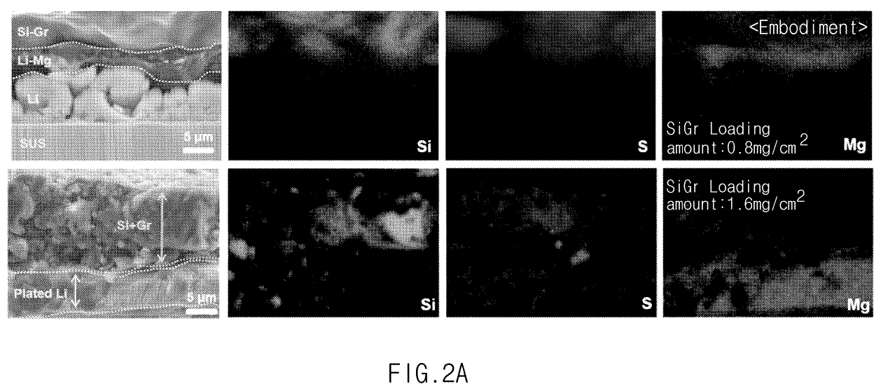

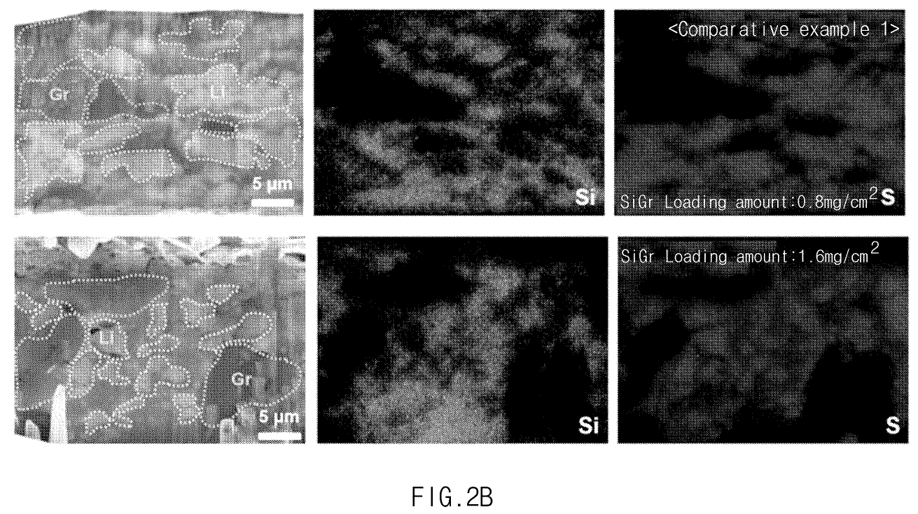

In the present experiment, the all-solid-state battery was prepared by using LPSCI as the solid electrolyte, NCM811 coated with LiNbO₃, which serves as a cathode, and Al for the cathode current collector. In addition, the all-solid-state battery was fully charged with power at a temperature of 25° C. and pressure of 20 MPa. The cross-sections of an electrode deposited with lithium corresponding to 3.5 mAh/cm are illustrated in FIGS. 2A and 2B.

As recognized through FIGS. 2A and 2B, according to the present disclosure, the embodiment employing the Si-graphite complex as the anode active material showed that lithium was uniformly deposited under the anode active material layer, regardless of the loading amount of the anode active material, preventing direct contact between lithium metal and the solid electrolyte. Compared to Comparative example 1, in the absence of the lithium-friendly metal layer, it was observed that lithium was precipitated in the electrode (or the anode). Accordingly, it may be recognized that the lithium-friendly metal layer according to the present disclosure attracts lithium, which is precipitated due to overcharging, to be deposited between the anode active material layer and the lithium-friendly metal layer.

### Experimental Example 2: Evaluation of Electrochemical Characteristic for Half-Cell

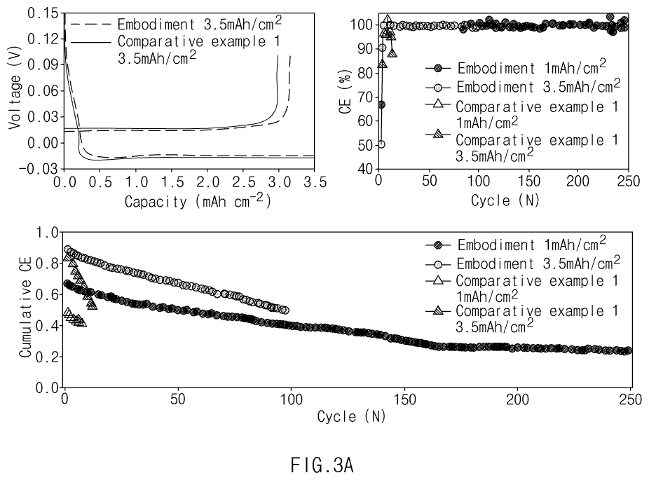

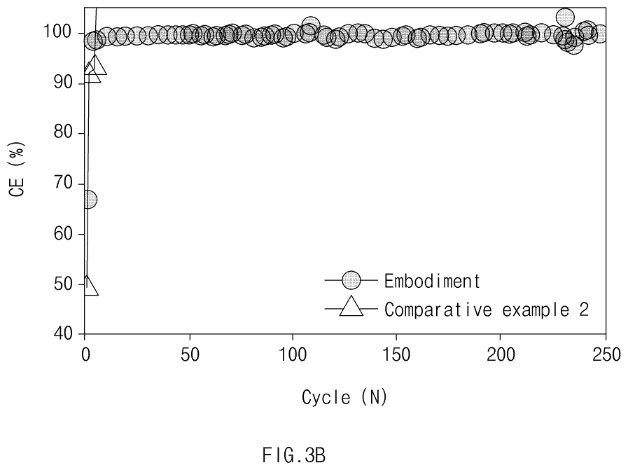

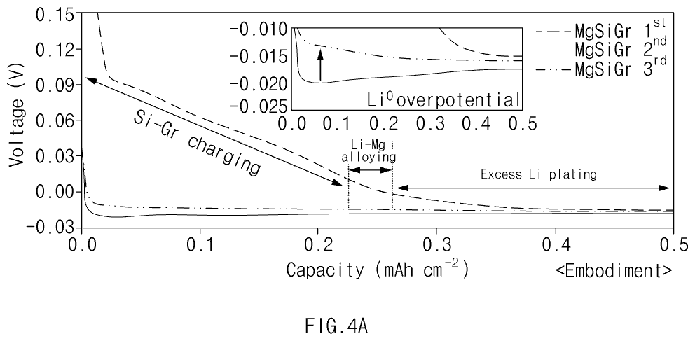

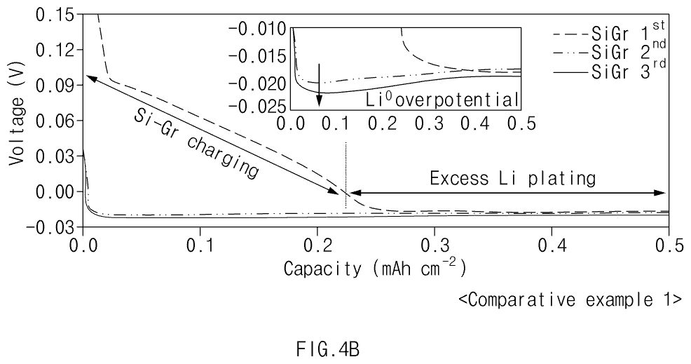

In this experiment, a half-cell was formed by using the anode for the all-solid-state battery prepared in the above embodiment and Comparative example 1, and the electrochemical characteristic for the half-cell was evaluated. Briefly, the half-cell was formed by using the anode for the all-solid-state battery prepared in the above embodiment and Comparative example 1, LPSCI, and lithium metal, and the charging/discharge condition was set to range from 0 V to 0.1 V. In addition, this experiment was performed under conditions where the temperature was 25° C., the pressure was 20 MPa, the loading amount of the anode active material was 0.8 mg/cm², and a current density for evaluation was controlled to 1.0 mA/cm². Thereafter, a voltage characteristic (v) in charging/discharging with the capacities of 1 mAh/cm² and 3.5 mAh/cm2, coulombic efficiency CE (%) depending on a charging/discharging cycle, a cumulative CE (%), and a voltage curve in charging are shown in FIGS. 3A, 4A, and 4B in the form of graphs.

As recognized through FIG. 3A, an electrode employing the anode according to an embodiment of the present disclosure completed charging/discharging, earlier than an anode according to the Comparative example, under the condition of the higher capacity of 3.5 mAh/cm². Accordingly, the anode according to an embodiment of the present disclosure showed initial efficiency which is improved than that of the anode according to the Comparative example. In addition, it may be recognized that the electrode according to an embodiment of the present disclosure showed uniform coulombic efficiency without earlier cell-short circuit even under the condition of the higher capacity of 3.5 mAh/cm², and was stably driven without the cell-short circuit for at least about 250 cycles under the capacity condition of 1 mAh/cm². That result contrasts from the results seen for the Comparative Example, in which the cell-short circuit occurs regardless of the capacity condition (Comparative example 1) without the lithium-friendly metal layer. Accordingly, it may be recognized that the lithium-friendly metal layer, according to the present disclosure, provides an improved initial efficiency characteristic, and charging/discharging is stably performed even under the condition of the higher capacity.

In addition, it may be recognized in FIGS. 4A and 4B that the electrode employing the anode according to an embodiment of the present disclosure was stabilized at an overvoltage, and thus an interface was stably formed, such that higher driving stability was realized. In contrast, an electrode employing the anode according to Comparative example 1 showed an overvoltage increased as a cycle was repeated, and a side reaction occurred at an electrode interface due to the deposited lithium exposed to show lower driving stability. Accordingly, the overvoltage was improved even under the overcharge condition to ensure the driving stability in an anode according to the present disclosure.

In addition, a half-cell was formed by using the anode for the all-solid-state battery prepared in the embodiment and Comparative example 2, and the electrochemical characteristic for the half-cell was evaluated. In this case, the half-cell was formed by using the anode for the all-solid-state battery prepared in the embodiment of the present disclosure and Comparative example 2, LPSCI, and lithium metal, and the charging/discharge condition was set to range from 0 V to 0.1 V. This experiment was performed at a temperature of 25° C., the pressure was 20 MPa, the loading amount of the anode active material was 0.56 mg/cm², a current density for evaluation was controlled to 1.0 mA/cm², and a charging capacity was controlled to 1 mA/cm². Thereafter, the coulombic efficiency was measured depending on a charging/discharging cycle using the anode according to an embodiment and Comparative example 2 and was shown, in the form of a graph, in FIG. 3B.

FIG. 3B shows that the electrode employing the anode according to an embodiment of the present disclosure operates stably without cell-short-circuiting even after more than 250 cycles, while Comparative example 2 having an anode active material without Si showed an earlier internal cell-short circuit. Accordingly, it may be recognized that the anode according to the present disclosure includes the anode active material layer including the Si-based anode active material, and provides for a cell that is stably driven without the cell-short-circuiting even after repeated cycles.

### Experimental Example 3: Evaluation of Electrochemical Characteristic for Full-Cell

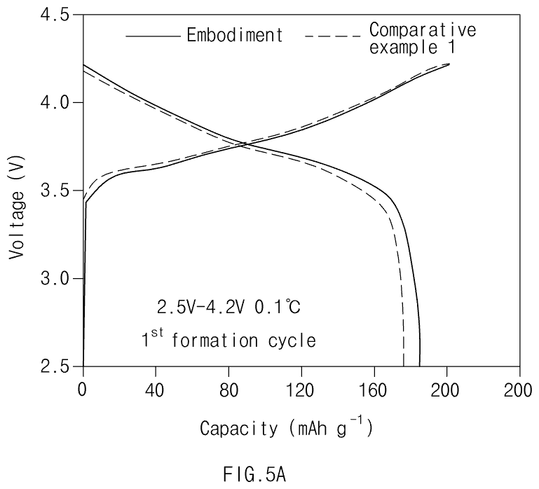

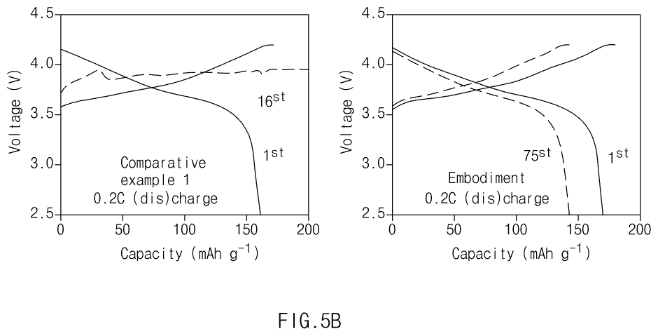

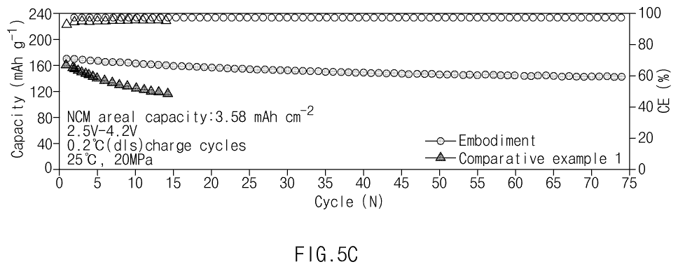

In this experiment, the electrochemical characteristic for a full-cell was evaluated by using the all-solid-state battery prepared in Experimental example 1 and by controlling the charging/discharging voltage condition from 2.5 V to 4.2 V. In addition, this experiment was performed at a temperature of 25° C., a pressure of 20 MPa, the loading amount of the active material was 0.8 mg/cm², and a current density for evaluation was controlled to 0.2 C (0.716 mA/cm²). Thereafter, a voltage and capacity characteristic in an initial cycle, a voltage and capacity characteristic as cycles proceed, and a capacity retention rate depending on a cycle number were shown in FIGS. 5A, 5B, and 5C, in the form of graphs.

As recognized through FIGS. 5A, 5B, and 5C, a cell employing the anode according to an embodiment of the present disclosure showed an initial efficiency that was improved relative to a cell employing the anode according to Comparative example 1. In addition, even if cycles are repeated, a stable voltage profile, a higher capacity retention rate, and a higher coulombic efficiency were observed for the cell according to the illustrative embodiment. Accordingly, the electrode employing the anode according to the present disclosure may show an excellent initial efficiency, may stably maintain a higher capacity and higher efficiency even if cycles proceed, and may show an excellent electrochemical characteristic.

According to the present disclosure, the anode for the all-solid-state battery comprises a structure in which the anode active material layer is stacked on the lithium-friendly metal layer. The lithium-friendly metal layer can induce the lithium to be deposited under the anode active material layer, and the deposited lithium metal can act as a barrier to prevent the direct reaction with the solid electrolyte. The anode active material layer includes the Si-based complex as the anode active material, thereby inducing the diffusion of the lithium ion, such that the lithium is more easily deposited. Accordingly, the anode according to the present disclosure is stably driven without a cell-short circuit under a higher capacity condition, as lithium deposition is stably induced without the growth of lithium dendrites, even if overcharging occurs with more than a theoretical capacity. In addition, the anode may stabilize the overvoltage, thereby showing higher driving stability.

While certain features of the present disclosure have been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the 10 following claims.

What is claimed is:

1. An anode for an all-solid-state battery, the anode comprising:
an anode current collector;
a lithium-friendly metal layer stacked on the anode current collector; and
an anode active material layer stacked on the lithium-friendly metal layer,
wherein the anode active material layer includes a Si-based anode active material.

2. The anode of claim 1, wherein the Si-based anode active material has an electrochemical theoretical capacity of at least 100 mAh/g.

3. The anode of claim 1, wherein the Si-based anode active material comprises a complex of Si or an active material selected from the group consisting of Si and graphite, lithium titanate (LTO), graphene, silicon-based oxide (Siox), and a metal oxide.

4. The anode of claim 1, wherein the Si-based anode active material is a Si-graphite complex.

5. The anode of claim 1, wherein the anode active material layer further includes a binder.

6. The anode of claim 1, wherein the anode active material layer comprises an active material loading amount ranging from 0.2 mg/cm² to 1.8 mg/cm².

7. The anode of claim 1, wherein the anode active material layer further includes a solid electrolyte.

8. The anode of claim 1, wherein the lithium-friendly metal layer includes:
at least one metal selected from the group consisting of Mg, Ag, Zn, Au, Ni, Co, Mn, Al, Cd, and Ti.

9. The anode of claim 1, wherein the lithium-friendly metal layer includes Mg.

10. The anode of claim 1, wherein the lithium-friendly metal layer has a thickness ranging from 10 nm to 5,000 nm.

11. The anode of claim 1, wherein the anode is configured to deposit lithium under an alloy of the lithium-friendly metal layer and lithium, when operated in an overcharged state.

12. A method for preparing an anode for an all-solid-state battery, the method comprising:
depositing a lithium-friendly metal layer on an anode current collector (S1);
preparing anode active material slurry including Si (S2); and
forming an anode active material layer by coating the anode active material slurry onto the lithium-friendly metal layer and drying the slurry to provide the anode (S3).

13. The method of claim 12, wherein the depositing of the lithium-friendly metal layer is performed by physical vapor deposition.

14. The method of claim 12, wherein the anode active material slurry has viscosity ranging from 100 cP and 200 cP.

15. The method of claim 12, wherein the drying is performed at a temperature ranging from 70° C. to 120° C.

16. An all-solid-state battery comprising the anode of claim 1.
